(19) United States
(12) Patent Application Publication
(10) Pub. No.: US 2026/0244330 A1
(43) Pub. Date: Aug. 20, 2026

(54) PAGE ANALYSIS METHOD, APPARATUS, ELECTRONIC DEVICE, STORAGE MEDIUM, AND PROGRAM PRODUCT

(71) Applicant: Beijing Volcano Engine Technology Co., Ltd., Beijing (CN)

(72) Inventors: Meitong YAN, Beijing (CN); Feng QIAN, Beijing (CN); Lingmin XU, Beijing (CN)

(21) Appl. No.: 19/539,953

(22) Filed: Feb. 13, 2026

(30) Foreign Application Priority Data
Feb. 14, 2025 (CN) 202510168013.8

(51) Int. Cl. G06F 3/0485; G06F 3/0482; G06F 3/04842; G06F 3/0488

(52) U.S. Cl. CPC G06F 3/0485; G06F 3/0482; G06F 3/04842; G06F 3/0488

(57) ABSTRACT

The present disclosure relates to the field of data analysis technologies and discloses a page analysis method and apparatus, an electronic device, a storage medium, and a program product. The method includes: determining a target analysis condition and a first page meeting the target analysis condition, in response to an interaction operation for an analysis condition area on an analysis page; and displaying the first page, a downstream page of the first page, and a link relationship between the pages in a display area on the analysis page by using a first view mode, where the downstream page is determined based on an operation link of the first page, and page analysis information about a corresponding page is displayed on the first page and the downstream page. The present disclosure may solve the problem that the result of page analysis is relatively weak.

### CROSS-REFERENCE TO RELATED APPLICATION(S)

This application claims priority to Chinese Application No. 202510168013.8 filed on February 14, 2025, the disclosure of which is incorporated herein by reference in its entirety.

### FIELD

The present invention relates to the field of data analysis technologies, and in particular, to a page analysis method and apparatus, an electronic device, a storage medium, and a program product.

### BACKGROUND

In page analysis, a path analysis tool or a conversion funnel analysis tool is generally used to analyze an operation path of a page, to obtain the number of clicks on the page. For example, in a video playback scenario, it is generally necessary to analyze an operation path for playing a video, to obtain the number of video clicks.

### SUMMARY

In view of this, the present invention provides a page analysis method and apparatus, an electronic device, a storage medium, and a program product.

According to a first aspect, the present disclosure provides a page analysis method. The method includes:

determining a target analysis condition and a first page meeting the target analysis condition, in response to an interaction operation for an analysis condition area on an analysis page; and

displaying the first page, a downstream page of the first page, and a link relationship between the pages in a display area on the analysis page by using a first view mode, where the downstream page is determined based on an operation link of the first page, and page analysis information about a corresponding page is displayed on the first page and the downstream page.

According to a second aspect, the present disclosure provides a page analysis apparatus. The apparatus includes:

a first interaction module configured to determine a target analysis condition and a first page meeting the target analysis condition, in response to an interaction operation for an analysis condition area on an analysis page; and

a first display module configured to display the first page, a downstream page of the first page, and a link relationship between the pages in a display area on the analysis page by using a first view mode, where the downstream page is determined based on an operation link of the first page, and page analysis information about a corresponding page is displayed on the first page and the downstream page.

According to a third aspect, the present disclosure provides an electronic device. The electronic device includes a memory and a processor. The memory and the processor are communicatively connected to each other. The memory stores computer instructions. The processor executes the computer instructions to perform the page analysis method according to the first aspect or any corresponding implementation thereof.

According to a fourth aspect, the present disclosure provides a computer-readable storage medium. The computer-readable storage medium stores computer instructions. The computer instructions are used to cause a computer to perform the page analysis method according to the first aspect or any corresponding implementation thereof.

According to a fifth aspect, the present disclosure provides a computer program product. The computer program product includes computer instructions. The computer instructions are used to cause a computer to perform the page analysis method according to the first aspect or any corresponding implementation thereof.

### BRIEF DESCRIPTION OF THE DRAWINGS

In order to more clearly describe the technical solutions in the specific implementations of the present disclosure or in the prior art, the following briefly introduces the drawings that need to be used in the description of the specific implementations or the prior art. Obviously, the drawings in the following description are some implementations of the present disclosure, and for those of ordinary skill in the art, other drawings may also be obtained from these drawings without creative effort.

FIG. 1 is a schematic flowchart of a page analysis method according to an embodiment of the present disclosure;

FIG. 2 is a schematic diagram of an analysis page according to an embodiment of the present disclosure;

FIG. 3 is a schematic flowchart of another page analysis method according to an embodiment of the present disclosure;

FIG. 4 is a schematic diagram of an image view according to an embodiment of the present disclosure;

FIG. 5 is a schematic diagram of a trend view according to an embodiment of the present disclosure;

FIG. 6 is a schematic diagram of a card view according to an embodiment of the present disclosure;

FIG. 7 is a schematic diagram of an operation view according to an embodiment of the present disclosure;

FIG. 8 is a schematic diagram of another operation view according to an embodiment of the present disclosure;

FIG. 9 is a schematic diagram of an interaction trajectory line according to an embodiment of the present disclosure;

FIG. 10 is a structural block diagram of a page analysis apparatus according to an embodiment of the present disclosure; and

FIG. 11 is a structural block diagram of an electronic device according to an embodiment of the present disclosure

### DETAILED DESCRIPTION OF EMBODIMENTS

In order to make the objectives, technical solutions, and advantages of the embodiments of the present disclosure clearer, the technical solutions in the embodiments of the present disclosure are clearly and completely described below with reference to the drawings in the embodiments of the present disclosure. Obviously, the described embodiments are some but not all of the embodiments of the present disclosure. All other embodiments obtained by those skilled in the art based on the embodiments of the present disclosure without creative effort shall fall within the protection scope of the present disclosure.

It may be understood that before the technical solutions disclosed in the embodiments of the present disclosure are used, the user shall be informed of the type, range of use, use scenarios, etc., of personal information involved in the present disclosure and obtain the authorization of the user in an appropriate manner in accordance with relevant laws and regulations.

For example, in response to reception of an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to select whether to "agree" or "disagree" to provide the personal information to the electronic device.

It may be understood that the above process of notifying and obtaining user authorization is only illustrative and does not limit the implementations of the present disclosure, and other manners that satisfy the relevant laws and regulations may also be applied to the implementations of the present disclosure.

It may be understood that the data involved in the technical solution (including but not limited to the data itself, acquisition or use of the data) shall comply with the requirements of corresponding laws, regulations, and related provisions.

In page analysis, a path analysis tool or a conversion funnel analysis tool is generally used to analyze an operation path of a page, to obtain the number of the clicks on the page. For example, in a video playback scenario, it is generally necessary to analyze an operation path for playing a video, to obtain the number of the video clicks. However, in the foregoing solution, when the page is analyzed, only data of the number of the page clicks on the analyzed page may be obtained, which renders the result of the page analysis relatively weak.

In view of this, according to an embodiment of the present disclosure, an embodiment of a page analysis method is provided. It should be noted that the steps shown in the flowchart of the drawings may be performed in a computer system, such as a set of computer-executable

instructions. Furthermore, although a logical order is shown in the flowchart, in some cases, the steps shown or described may be performed in an order different from that herein.

In this embodiment, a page analysis method is provided, which may be used for an electronic device, such as a mobile phone, a tablet computer, etc. FIG. 1 is a schematic flowchart of a page analysis method according to an embodiment of the present disclosure. As shown in FIG. 1, the process includes the following steps.

Step S101: a target analysis condition and a first page meeting the target analysis condition are determined, in response to an interaction operation for an analysis condition area on an analysis page.

Specifically, the analysis condition area includes an input control for each item of the analysis information, where the analysis information includes at least one of page information or analysis time. The page information includes at least one of product information of a product to which the page belongs, or page description information (such as a page name, etc.). Furthermore, the analysis information may also include other information related to page analysis, which is not limited herein.

Furthermore, the target analysis condition is determined in response to input information for the input control of each item of the analysis information, and the first page is determined based on the target analysis condition.

Specifically, the target analysis condition includes at least one of target product information or target analysis time information. Furthermore, the target analysis condition may also include other analysis conditions related to page analysis, which are not limited herein.

In actual applications, a query control is further displayed on the analysis page. After the analysis condition is input through the input control of each item of the analysis information, the first page corresponding to the target analysis condition is obtained by query in response to an interaction operation for the query control. Furthermore, the page analysis information about the first page, the downstream page of the first page, the page analysis information about the downstream page, etc. are also obtained by synchronous query.

Step S102: the first page, the downstream page of the first page, and the link relationship between the pages are displayed in the display area on the analysis page by using the first view mode, where the downstream page is determined based on the operation link of the first page, and the page analysis information about the corresponding page is displayed on the first page and the downstream page.

Optionally, the first view mode includes at least one of an image view, a trend view, a card view, or an operation view. Furthermore, the first view mode may also be adjusted based on the actual situation, which is not limited herein.

In an actual situation, the first page and the downstream page may be displayed in a same view mode or different view modes. For example, the first page is displayed in the image view, and the downstream page is displayed in the card view. Different downstream pages may also be displayed in different view modes. For example, the downstream page 1 is displayed in the card view, and the downstream page 2 is displayed in the operation view.

It should be noted that, in addition to the link relationship between the first page and the downstream page, the link relationship between the pages further includes the link relationship between downstream pages at adjacent levels when the first page has multiple levels of downstream pages.

Optionally, the page analysis information includes at least one of an interaction analysis result of each functional area in the corresponding page, indicator trend information on at least one first analysis indicator, an analysis result of at least one second analysis indicator, interaction object information, or an interaction analysis result of an interaction area. Furthermore, the page analysis information may also be adjusted based on the actual situation, which is not limited herein.

In the page analysis method provided in this embodiment, after the first page to be analyzed is determined, the downstream page of the first page and the link relationship between the pages are displayed on the analysis page. Therefore, the operation link of the first page may be intuitively displayed. In addition, the page analysis information about the corresponding page is displayed on the first page and the downstream page. Therefore, the page analysis information about the downstream page may be used to deeply analyze the page condition of each page in the operation link of the first page, to make the analysis result of the first page more comprehensive and in-depth, thereby effectively solving the problem that the result of the page analysis is weak. In addition, the page analysis method may also be used to deeply analyze a page with less interaction in the operation link of the first page, to optimize the page with less interaction, thereby improving the page display effect.

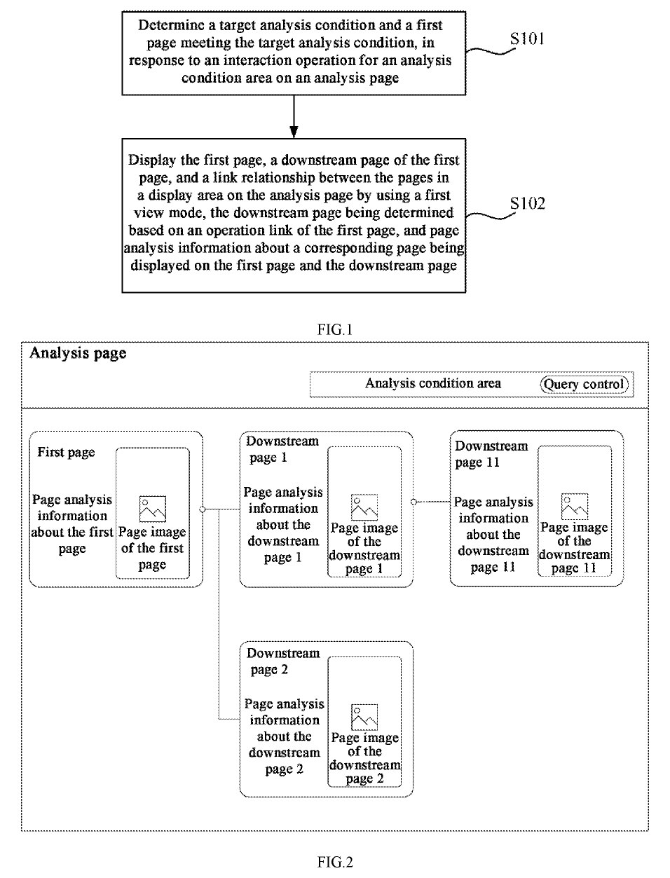

Exemplarily, referring to FIG. 2, the analysis condition area is displayed on the analysis page. The user may input the target analysis condition into the analysis condition area, and click the query control. The electronic device determines the target analysis condition in response to the interaction operation for the query control, and queries for the first page meeting the target analysis condition. Furthermore, the page analysis information about the first page, the downstream page of the first page, the page analysis information about the downstream page, etc. are also queried for. The first page, the downstream page, the link relationship between the pages, and the page analysis information about each page are displayed on the analysis page. For example, as shown in FIG. 2, the first page, the downstream page 1 of the first page, the downstream page 2, the downstream page 11, and the link relationship between the pages are displayed by using the first view mode (the card view in FIG. 2). The page analysis information about the corresponding page is displayed on each of the first page and each downstream page.

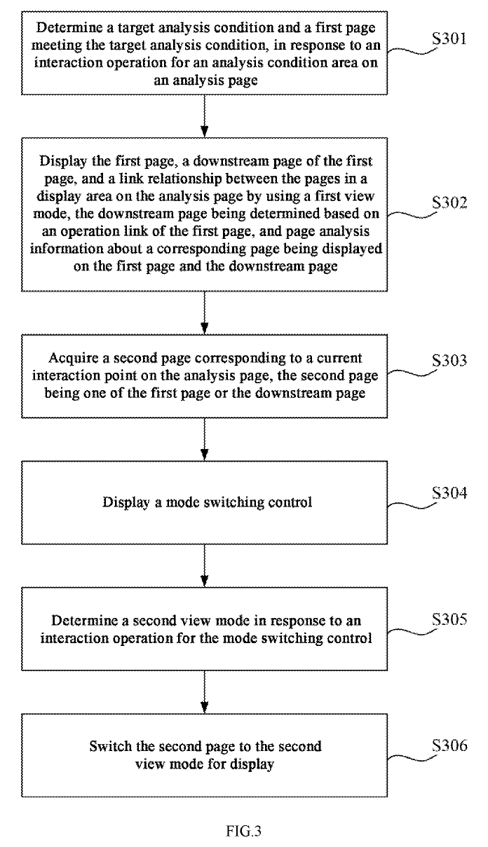

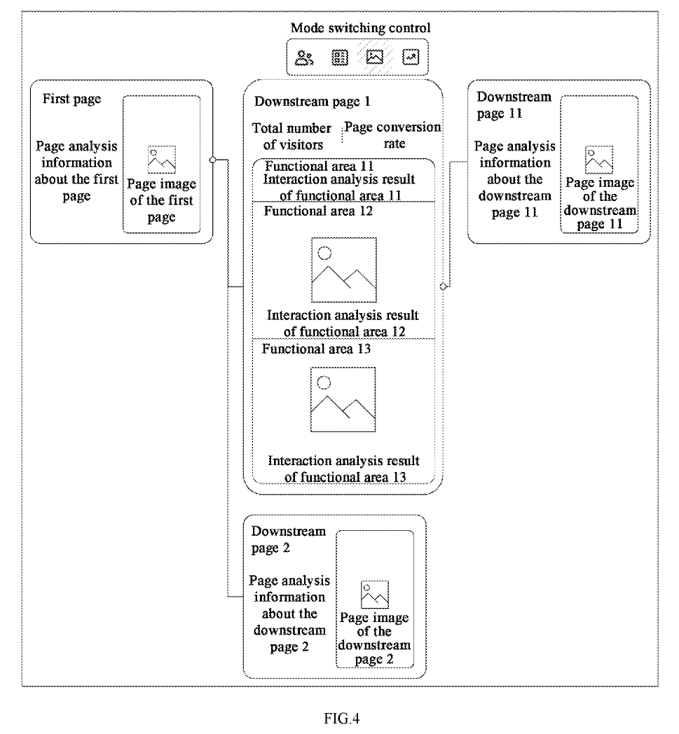

In this embodiment, another page analysis method is provided, which may be used for an electronic device, such as a mobile phone, a tablet computer, etc. FIG. 3 is a schematic flowchart of a page analysis method according to an embodiment of the present disclosure. As shown in FIG. 3, the process includes the following steps.

Step S301: a target analysis condition and a first page meeting the target analysis condition are determined, in response to an interaction operation for an analysis condition area on an analysis page. Reference may be made to step S101 described above, and details are not described herein again.

Step S302: the first page, a downstream page of the first page, and a link relationship between the pages are displayed in a display area on the analysis page by using a first view mode, where the downstream page is determined based on an operation link of the first page, and page analysis information about a corresponding page is displayed on the first page and the downstream page. Reference may be made to step S102 described above, and details are not described herein again.

Step S303: a second page corresponding to a current interaction point on the analysis page is acquired, where the second page is one of the first page or the downstream page.

It may be understood that if the current interaction point is located in the first page, the first page is used as the second page. If the current interaction point is located in any downstream page, the downstream page is used as the second page.

Step S304: a mode switching control is displayed.

Optionally, the mode switching control includes a switching control for at least one view mode, such as a switching control for an image view, a switching control for a trend view, a switching control for a card view, or a switching control for an operation view.

Alternatively, the mode switching control is used to trigger display of at least one view mode. The user may switch the view mode of the second page by selecting the view mode.

Optionally, the mode switching control is displayed in a corresponding area of the second page, for example, the upper right of the second page. Each page has a corresponding mode switching control.

In actual applications, the mode switching control of the second page may be displayed on the corresponding area of the second page after the second page is selected, or the mode switching control corresponding to each page may be displayed in the corresponding area of the first page and the downstream page before the second page is selected, which is not limited herein.

Step S305: a second view mode is determined in response to an interaction operation for the mode switching control.

For example, if the mode switching control for interaction is the switching control of the image view, it is determined that the second view mode of the second page is the image view. If the mode switching control for interaction is the switching control for the trend view, it is determined that the second view mode of the second page is the trend view. If the mode switching control for interaction is the switching control for the card view, it is determined that the second view mode of the second page is the card view. If the mode switching control for interaction is the switching control for the operation view, it is determined that the second view mode of the second page is the operation view.

Step S306: the second page is switched to the second view mode for display.

For example, if the second view mode is the image view, the second page is switched to the image view for display. If the second view mode is the trend view, the second page is switched to the trend view for display. If the second view mode is the card view, the second page is switched to the card view for display. If the second view mode is the operation view, the second page is switched to the operation view for display.

It should be noted that if the selected second view mode is the same as the first view mode, the display of the second page is not switched.

In the page analysis method provided in this embodiment, the mode switching control is used to switch the second page to the second view mode for display. Therefore, the view mode of the second page may be switched based on the actual demand, so that the page analysis information about the second page corresponding to different view modes may be viewed by switching the view mode, to perform comprehensive analysis on the second page.

In some optional implementations, the second view mode includes an image view, the second page is displayed in a form of a first image, the page analysis information includes an interaction analysis result of each functional area in the second page, the page image of the second page is displayed on the second page, and the page analysis information about the second page is displayed over the functional area corresponding to the page image.

Optionally, the page image of the second page is a thumbnail.

Furthermore, in the image view, the page analysis information further includes an overall page analysis result of the second page, and the page analysis result includes at least one of a total number of visitors, or a page conversion rate, where the page conversion rate is a ratio of a number of visitors who satisfy a target behavior corresponding to the second page to the total number of visitors, and the page conversion rate is used to analyze a conversion of the number of clicks on the second page. Furthermore, the page analysis information may also include other page analysis information related to the second page.

Furthermore, the interaction analysis result of each functional area includes at least one of a number of unique visitors (UVs) in the functional area, a proportion of the number of UVs in the functional area to a total number of UVs in the second page, a number of page views (PVs) in the functional area, a proportion of the number of PVs in the functional area to a total number of PVs in the second page, a change amplitude of the proportion of the number of UVs in the functional area within a preset time period, or a change amplitude of the proportion of the number of PVs in the functional area within a preset time period. Furthermore, the interaction analysis result of the functional area may also include other interaction analysis results related to the functional area, which is not limited herein.

In the page analysis method provided in this embodiment, in the image view, the interaction analysis result of the corresponding functional area is displayed over the functional area corresponding to the second page. Therefore, the interaction analysis result of each functional area in the second page may be intuitively displayed, to facilitate analysis of a distribution of the number of clicks on each functional area, thereby determining a functional area with less interaction in the second page, and further optimizing the functional area or a functional area layout of the second page, to improve the page display effect of the second page.

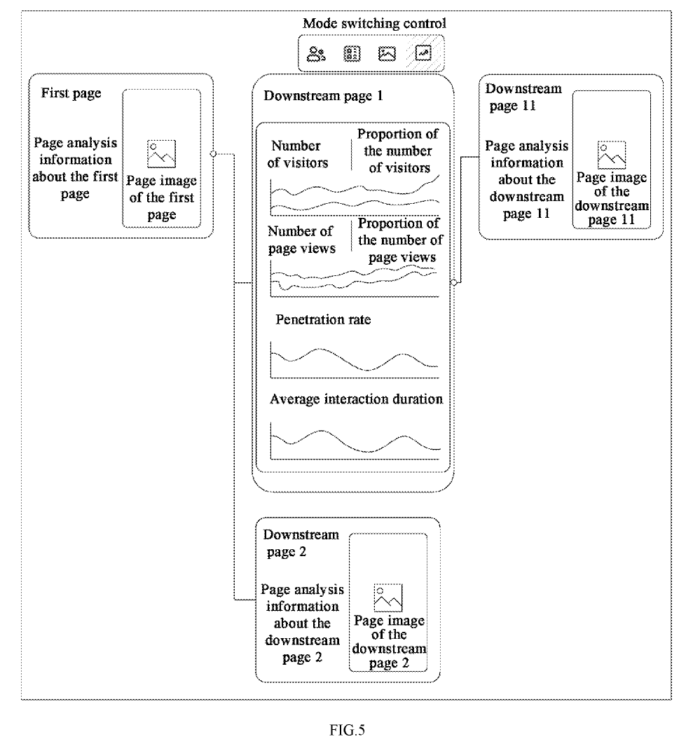

Exemplarily, referring to FIG. 4, taking the downstream page 1 being the second page as an example, the mode switching control is displayed above the downstream page 1. After the switching control for the image view in the mode switching control is selected, the downstream page 1 in the card view shown in FIG. 2 is switched to the image view for display. The downstream page 1 in the image view displays the overall page analysis result of the downstream page 1, such as the total number of visitors, and the page conversion rate. The interaction analysis result of the corresponding functional area is displayed over each functional area (such as the functional area 11, the functional area 12, and the functional area 13) of the downstream page 1.

In some optional implementations, the second view mode includes a trend view, the page analysis information includes indicator trend information on at least one first analysis indicator, the second page is represented in a form of a second image, and the indicator trend information on the at least one first analysis indicator is displayed on the second page.

Optionally, the first analysis indicator includes at least one of a number of visitors to the second page (mainly referring to a number of unique visitors), a proportion of a number of visitors who satisfy a target behavior corresponding to the second page among the visitors to the second page, a number of page views of the second page, a proportion of a number of page views that satisfy the target behavior corresponding to the second page among the number of page views of the second page, a penetration rate of the second page, or an average interaction duration of the second page. Furthermore, the first analysis indicator may also include other analysis indicators related to the second page, which is not limited herein.

In the page analysis method provided in this embodiment, the indicator trend information of the first analysis indicator of the second page is displayed in the trend view. Therefore, the change and fluctuation of each first analysis indicator of the second page may be intuitively displayed based on the displayed indicator trend information, to facilitate horizontal comparison of the first analysis indicator and an indicator change situation of each page in the operation link. The page with abnormal data is located in the operation link of the first page, to specifically solve the page problem.

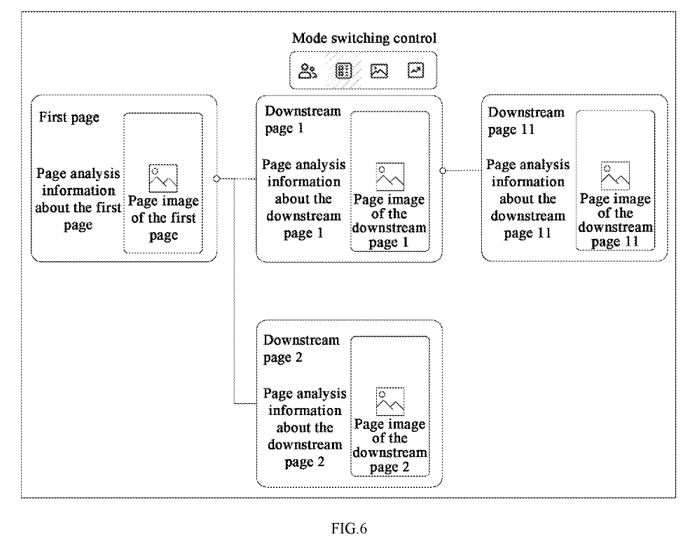

Exemplarily, referring to FIG. 5, taking the downstream page 1 being the second page as an example, after the switching control for the trend view in the mode switching control is selected, the downstream page 1 in the card view shown in FIG. 2 is switched to the trend view for display. For example, as shown in FIG. 5, trend information about the number of visitors to the downstream page, the proportion of the number of visitors, the number of page views, the proportion of the number of page views, the penetration rate, and the average interaction duration is displayed on the downstream page 1 in a form of a trend chart.

In some optional implementations, the second view mode includes a card view, the second page is represented in a form of a card, the page analysis information includes an analysis result of at least one second analysis indicator, and the analysis result of the at least one second analysis indicator and a page image of the second page are displayed on the second page.

Optionally, the second analysis indicator includes at least one of a total number of visitors to the second page (mainly referring to a number of unique visitors), a total number of interactions on the second page, a page conversion rate of the second page, or a conversion rate of a previous step that triggers display of the second page (that is, a ratio of a number of operations that satisfy the target behavior in the previous step to a total number of operations in the previous step). Furthermore, the second analysis indicator may also include other analysis indicators related to the second page, which are not limited herein.

In the page analysis method provided in this embodiment, the analysis result of the second analysis indicator of the second page and the page image are displayed in the card view. Therefore, the analysis result of the second analysis indicator of each page in the operation link of the first page and the thumbnail (that is, the page image) of each page may be overviewed in the form of the card view, to browse the operation link of the first page more globally.

Compared with the related art, in which the page analysis information of only one page may be viewed at a time, the page analysis method in this embodiment may use the card view to overview the core indicator data and the page thumbnail of each page, to analyze the operation link of the first page more globally.

Exemplarily, as shown in FIG. 6, taking the downstream page 1 being the second page as an example, if the downstream page 1 is initially displayed in a view mode other than the card view, such as the image view, after the switching control of the card view in the mode switching control is selected, the downstream page 1 is switched to the card view shown in FIG. 6 for display.

In some optional implementations, the second view mode includes an operation view, the page image of the second page and the interaction object information about the second page are displayed on the second page, the interaction analysis result of the interaction area is displayed over the interaction area of the page image, and the page analysis information includes the interaction object information and the interaction analysis result of the interaction area.

Optionally, the interaction analysis result of the interaction area includes at least one of a number of visitors to the interaction area, a number of interactions in the interaction area, or a proportion of the number of the interactions in the interaction area to a total number of interactions in the second page. Furthermore, the interaction analysis result of the interaction area may also include other analysis results related to the interaction area, which are not limited herein.

Optionally, the interaction object information includes at least one of an object name or an object identification of the interaction object that interacts with the second page. Furthermore, the interaction object information may also include other information of the interaction object, such as an avatar of the interaction object.

In the page analysis method provided in this embodiment, in the operation view, the interaction analysis result of the interaction area is displayed over the interaction area of the page image, and the interaction object information about the second page is displayed. Therefore, the interaction object that browses the second page may be analyzed in the operation view, the area in the second page that interacts with the interaction object may be analyzed, and the interaction situation of each area in the second page may be analyzed, to facilitate analysis of the area with a better display effect in the second page.

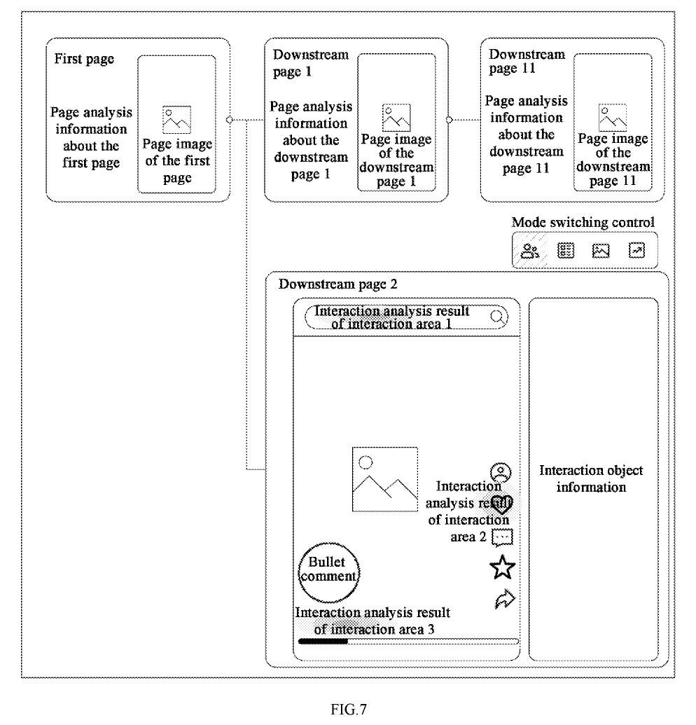

Exemplarily, as shown in FIG. 7, taking the downstream page 2 being the second page as an example, if the switching control for the operation view in the mode switching control is selected, the downstream page 2 in the card view shown in FIG. 2 is switched to the operation view for display. For example, as shown in FIG. 7, the interaction analysis result of the corresponding interaction area is displayed over the interaction area 1, the interaction area 2, and the interaction area 3 of the downstream page 2. The interaction object information about the second page, such as the object name and the object identification of the interaction object, is displayed on one side of the page image of the second page.

In some optional implementations, the page analysis method of the present disclosure further includes: displaying the page image of the second page and the interaction object information about a first interaction area in response to a selection operation for the first interaction area.

Optionally, the page image of the second page is a thumbnail.

It should be noted that when the first interaction area is selected, the interaction object information about other interaction areas is not displayed.

In the page analysis method provided in this embodiment, after the first interaction area is selected, only the interaction object information about the first interaction area is displayed. Therefore, the interaction object information about the first interaction area of interest may be highlighted, to facilitate analysis of the information about the interaction object that interacts with the first interaction area.

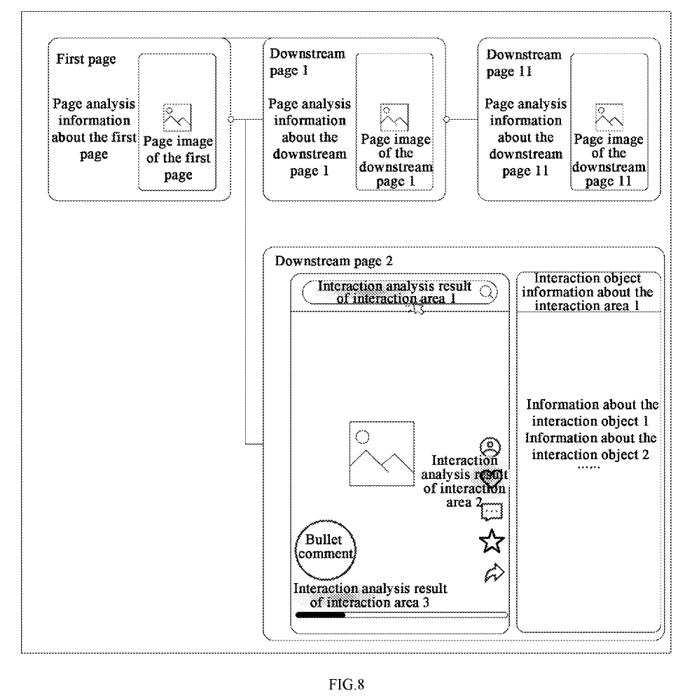

Exemplarily, as shown in FIG. 8, taking the downstream page 2 being the second page as an example, if the switching control for the operation view in the mode switching control is selected, the downstream page 2 in the card view shown in FIG. 2 is switched to the operation view for display. For example, as shown in FIG. 8, if the interaction area 1 is selected, only the interaction object information about the interaction area 1 is displayed, such as information about the interaction object 1, information about the interaction object 2, etc.

In some optional implementations, the page analysis method of the present disclosure further includes: displaying an interaction description of a target interaction object corresponding to the second page in response to a selection operation for the target interaction object in the interaction object information about the first interaction area, where the interaction description includes an interaction event and an interaction time corresponding to the interaction event.

It should be noted that, in addition to selecting the target interaction object from the interaction object information about the first interaction area, the target interaction object may also be selected from all interaction object information about the second page, which is not limited herein.

In the page analysis method provided in this embodiment, after the target interaction object is selected, the interaction event of the target interaction object corresponding to the second page and the interaction time of the interaction event are displayed. Therefore, it is convenient to analyze the browsing behavior and operation behavior of the target interaction object on the second page.

In some optional implementations, the page analysis method of the present disclosure further includes: further displaying at least one interaction trajectory line in the page image of the second page, where a number of interaction trajectory lines is determined based on a time interval between two adjacent interaction events, the interaction event corresponds to an interaction position in the page image of the second page, and the interaction trajectory line is used to represent a connection line between the interaction positions.

It should be noted that if the time interval between the two adjacent interaction events is less than a preset interval threshold, the interaction trajectory line between the two adjacent interaction events in the second page is constructed based on the interaction positions of the two adjacent interaction events in the second page. If the time interval between the two adjacent interaction events is greater than or equal to the preset interval threshold, the interaction trajectory line between the two adjacent interaction events on the second page is not constructed.

In the page analysis method provided in this embodiment, after the target interaction object is selected, the interaction trajectory line corresponding to the interaction event is displayed in the page image of the second page. Therefore, it is convenient to analyze the operation behavior flow of the target interaction object on the second page.

Exemplarily, as shown in FIG. 9, taking the second page being the downstream page 2 and the target interaction object being the interaction object 1 as an example, the interaction description of the interaction object 1 corresponding to the downstream page 2 is displayed. For example, the interaction object 1 gives a like to the video in the downstream page 2 at 09:00:50, adds the video in the downstream page 2 to favorites at 09:00:51, clicks on the search area in the downstream page 2 at 09:01:10, slides the progress bar in the downstream page 2 at 09:03:50, sends a bullet comment in the video of the downstream page 2 at 09:04:30, and scrolls up the video in the downstream page 2 at 09:04:50. Since the time interval between the interaction time of the interaction event of clicking on the search area and the interaction time of the interaction event of sliding the progress bar is greater than the preset interval threshold, the interaction trajectory lines between the like control, the favorite control, and the search area are displayed in the page image of the downstream page 2, and the interaction trajectory lines between the interaction positions of the progress bar, the bullet comment control, and the scroll-up video are displayed in the page image of the downstream page 2.

Furthermore, in the page analysis method of the present disclosure, the behavior path is carried using a canvas, which supports the user to add a downstream page horizontally or vertically.

In some optional implementations, at least one level of downstream page is displayed on the analysis page, the downstream pages at the same level are arranged and displayed in a preset direction (such as a vertical direction), and a first expansion control is displayed in an area corresponding to each level of the analysis page, where the first expansion control is used to trigger display of other downstream pages that are not displayed at that level.

In some optional implementations, a second expansion control is displayed in a corresponding area of the downstream page, and the second expansion control is used to trigger display of a downstream page at a next level of the downstream page.

As a specific application example, a target application is installed on the electronic device, and the target application is used to analyze a page. The user may input a target analysis condition into an analysis condition area on an analysis page displayed by the target application, to determine a first page to be analyzed. Then, the target application uses the page analysis method of the present disclosure to display the first page and a downstream page of the first page. The user selects any of the pages as a second page, and uses a mode switching control of the second page to switch a view mode of the second page, to display different types of analysis information of the second page in different view modes, so as to facilitate analysis of the first page and the downstream page in multiple dimensions.

In this embodiment, a page analysis apparatus is further provided. The apparatus is configured to implement the above embodiments and preferred implementations, which will not be repeated herein. As used below, the term "module" may implement a combination of software and/or hardware for a predetermined function. Although the apparatus described in the following embodiments is preferably implemented in software, implementation in hardware, or a combination of software and hardware is also possible and contemplated.

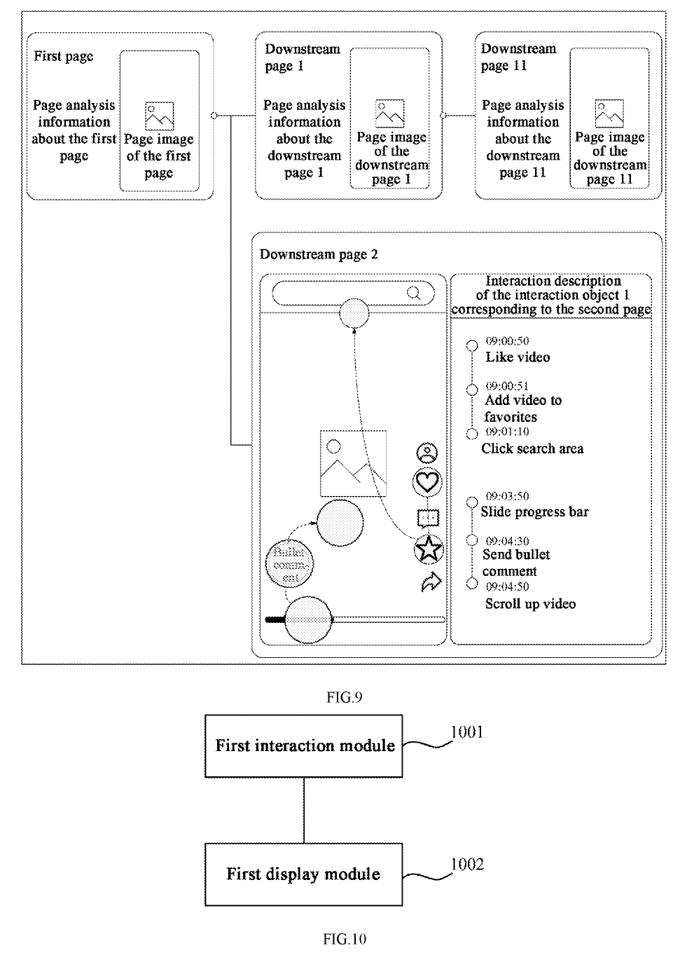

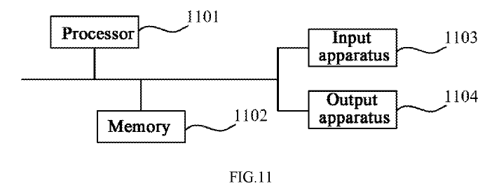

This embodiment provides a page analysis apparatus. As shown in FIG. 10, the apparatus includes:

a first interaction module 1001 configured to determine a target analysis condition and a first page meeting the target analysis condition, in response to an interaction operation for an analysis condition area on an analysis page; and

a first display module 1002 configured to display the first page, a downstream page of the first page, and a link relationship between the pages in a display area on the analysis page by using a first view mode, where the downstream page is determined based on an operation link of the first page, and page analysis information about a corresponding page is displayed on the first page and the downstream page.

In some optional implementations, the page analysis apparatus of the present disclosure further includes:

a page determination module configured to acquire a second page corresponding to a current interaction point on the analysis page, where the second page is one of the first page or the downstream page;

a second display module configured to display a mode switching control;

a view determination module configured to determine a second view mode in response to an interaction operation for the mode switching control; and

a view switching module configured to switch the second page to the second view mode for display.

In some optional implementations, the second view mode includes an image view, the second page is displayed in a form of a first image, the page analysis information includes an interaction analysis result of each functional area in the second page, a page image of the second page is displayed on the second page, and the page analysis information about the second page is displayed over the functional area corresponding to the page image.

In some optional implementations, the second view mode includes a trend view, the page analysis information includes indicator trend information on at least one first analysis indicator, the second page is represented in a form of a second image, and the indicator trend information on the at least one first analysis indicator is displayed on the second page.

In some optional implementations, the second view mode includes a card view, the second page is represented in a form of a card, the page analysis information includes an analysis result of at least one second analysis indicator, and the analysis result of the at least one second analysis indicator and a page image of the second page are displayed on the second page.

In some optional implementations, the second view mode includes an operation view, the page image of the second page and the interaction object information about the second page are displayed on the second page, the interaction analysis result of the interaction area is displayed over the interaction area of the page image, and the page analysis information includes the interaction object information and the interaction analysis result of the interaction area.

In some optional implementations, the page analysis apparatus of the present disclosure further includes:

an information display module configured to display the page image of the second page and the interaction object information about a first interaction area in response to a selection operation for the first interaction area.

In some optional implementations, the page analysis apparatus of the present disclosure further includes:

a description display module configured to display an interaction description of a target interaction object corresponding to the second page in response to a selection operation for the target interaction object in the interaction object information about the first interaction area, where the interaction description includes an interaction event and an interaction time corresponding to the interaction event.

In some optional implementations, the page analysis apparatus of the present disclosure further includes:

a trajectory display module configured to display at least one interaction trajectory line in the page image of the second page, where a number of interaction trajectory lines is determined based on a time interval between two adjacent interaction events, the interaction event corresponds to an interaction position in the page image of the second page, and the interaction trajectory line is used to represent a connection line between the interaction positions.

Further function descriptions of the above modules and units are the same as those in the corresponding embodiments described above, and details are not described herein again.

The page analysis apparatus in this embodiment is presented in the form of a functional unit. Here, the unit refers to an ASIC (Application Specific Integrated Circuit) circuit, a processor and a memory that execute one or more software or fixed programs, and/or other devices that may provide the above functions.

An embodiment of the present disclosure further provides an electronic device having the page analysis apparatus shown in FIG. 10.

Referring to FIG. 11, FIG. 11 is a structural block diagram of an electronic device according to an optional embodiment of the present disclosure. As shown in FIG. 11, the electronic device includes one or more processors 1101, a memory 1102, and interfaces for connecting various components, including high-speed interfaces and low-speed interfaces. The components communicate with each other using different buses and may be installed on a common main board or in other manners as needed. The processor may process instructions executed within the electronic device, including instructions stored in or on the memory to display graphical information of a GUI on an external input/output apparatus (such as a display device coupled to the interface). In some optional implementations, if required, multiple processors and/or buses may be used with multiple memories and multiple memories. Similarly, multiple electronic devices may be connected, and each device provides some necessary operations (for example, as a server array, a group of blade servers, or a multi-processor system). In FIG. 11, one processor 1101 is used as an example.

The processor 1101 may be a central processing unit, a network processor, or a combination thereof. Furthermore, the processor 1101 may further include a hardware chip. The hardware chip may be an application specific integrated circuit, a programmable logic device, or a combination thereof. The programmable logic device may be a complex programmable logic device, a field programmable logic gate array, a generic array logic, or any combination thereof.

The memory 1102 stores instructions executable by at least one processor 1101, so that the at least one processor 1101 executes the method shown in the above embodiments.

The memory 1102 may include a program storage area and a data storage area, where the program storage area may store an application program required by an operating system and at least one function; and the data storage area may store data created according to the use of the electronic device, etc. Furthermore, the memory 1102 may include a high-speed random access memory or a non-transitory memory, such as at least one magnetic disk storage device, a flash memory device, or other non-transitory solid-state storage devices. In some optional implementations, the memory 1102 optionally includes memories remotely provided with respect to the processor 1101, and these remote memories may be connected to the electronic device through a network. Examples of the above network include, but are not limited to, Internet, an intranet, a local area network, a mobile communication network, and a combination thereof.

The memory 1102 may include a volatile memory, such as a random access memory; the memory may also include a non-volatile memory, such as a flash memory, a hard disk, or a solid state disk; the memory 1102 may also include a combination of the above types of memories.

The electronic device further includes an input apparatus 1103 and an output apparatus 1104. The processor 1101, the memory 1102, the input apparatus 1103, and the output apparatus 1104 may be connected through a bus or in other manners. In FIG. 11, connection through a bus is used as an example.

The input apparatus 1103 may receive input digital or character information, and generate a key signal input related to user settings and function control of the electronic device, such as a touch screen, a keypad, a mouse, a track pad, a touch panel, an indicator stick, one or more mouse buttons, a trackball, a joystick, etc. The output apparatus 1104 may include a display device, an auxiliary lighting apparatus (such as an LED), a tactile feedback apparatus (such as a vibration motor), etc. The above display device includes, but is not limited to, a liquid crystal display, a light emitting diode, a display, and a plasma display. In some optional implementations, the display device may be a touch screen.

An embodiment of the present disclosure further provides a computer-readable storage medium. The method according to the embodiments of the present disclosure may be implemented in hardware and firmware, or implemented as computer code that may be recorded in a storage medium or originally stored in a remote storage medium or a non-transitory machine-readable storage medium and downloaded through a network and to be stored in a local storage medium. Therefore, the method described herein may be performed by such software stored on a storage medium using a general-purpose computer, a dedicated processor, or programmable or dedicated hardware. The storage medium may be a magnetic disk, an optical disk, a read-only memory, a random access memory, a flash memory, a hard disk, or a solid state disk, etc. Furthermore, the storage medium may further include a combination of the above types of memories. It may be understood that the computer, the processor, the microprocessor controller, or the programmable hardware includes a storage component that may store or receive software or computer code. When the software or computer code is accessed and executed by the computer, the processor, or the hardware, the method shown in the above embodiments is implemented.

A part of the present disclosure may be applied as a computer program product, such as computer program instructions that, when executed by a computer, may invoke or provide the method and/or technical solution according to the present disclosure through the operation of the computer. Those skilled in the art should understand that the computer program instructions exist in the computer-readable medium in a form including, but not limited to, a source file, an executable file, an installation package file, etc. Accordingly, the computer program instructions are executed by the computer in a manner including, but not limited to, the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium accessible by the computer.

Although the embodiments of the present disclosure are described with reference to the drawings, those skilled in the art may make various modifications and variations without departing from the spirit and scope of the present disclosure, and such modifications and variations fall within the scope defined by the appended claims.

We claim:

1. A page analysis method, comprising:
determining a target analysis condition and a first page meeting the target analysis condition, in response to an interaction operation for an analysis condition area on an analysis page; and
displaying the first page, a downstream page of the first page, and a link relationship between the pages in a display area on the analysis page by using a first view mode, the downstream page being determined based on an operation link of the first page, and page analysis information about a corresponding page being displayed on the first page and the downstream page.

2. The method of claim 1, further comprising:
acquiring a second page corresponding to a current interaction point on the analysis page, the second page being one of the first page or the downstream page;
displaying a mode switching control;
determining a second view mode in response to an interaction operation for the mode switching control; and
switching the second page to the second view mode for display.

3. The method of claim 2, wherein the second view mode comprises an image view, the second page is displayed in a form of a first image, the page analysis information comprises an interaction analysis result of respective functional areas on the second page, a page image of the second page is displayed on the second page, and the page analysis information about the second page is displayed over the functional area corresponding to the page image.

4. The method of claim 2, wherein the second view mode comprises a trend view, the page analysis information comprises indicator trend information on at least one first analysis indicator, the second page is represented in a form of a second image, and the indicator trend information on the at least one first analysis indicator is displayed on the second page.

5. The method of claim 2, wherein the second view mode comprises a card view, the second page is represented in a form of a card, the page analysis information comprises an analysis result of at least one second analysis indicator, and the analysis result of the at least one second analysis indicator and a page image of the second page are displayed on the second page.

6. The method of claim 2, wherein the second view mode comprises an operation view, the page image of the second page and the interaction object information about the second page are displayed on the second page, the interaction analysis result of the interaction area is displayed over the interaction area of the page image, and the page analysis information comprises the interaction object information and the interaction analysis result of the interaction area.

7. The method of claim 6, further comprising:
displaying the page image of the second page and the interaction object information about a first interaction area in response to a selection operation for the first interaction area.

8. The method of claim 7, further comprising:
displaying an interaction description of a target interaction object corresponding to the second page in response to a selection operation for the target interaction object in the interaction object information about the first interaction area, the interaction description comprising an interaction event and an interaction time corresponding to the interaction event.

9. The method of claim 8, further comprising:
displaying at least one interaction trajectory line in the page image of the second page, a number of the at least one interaction trajectory line being determined based on a time interval between two adjacent interaction events, the interaction event corresponding to an interaction position in the page image of the second page, and the interaction trajectory line being used to represent a connection line between the interaction positions.

10. An electronic device, comprising:
a memory and a processor, wherein the memory and the processor are communicatively connected to each other, the memory stores computer instructions, and the computer instructions, when executed by the processor, cause the electronic device to:
determine a target analysis condition and a first page meeting the target analysis condition, in response to an interaction operation for an analysis condition area on an analysis page; and
display the first page, a downstream page of the first page, and a link relationship between the pages in a display area on the analysis page by using a first view mode, the downstream page being determined based on an operation link of the first page, and page analysis information about a corresponding page being displayed on the first page and the downstream page.

11. The electronic device of claim 10, wherein the computer instructions, when executed by the processor, further cause the electronic device to:
acquire a second page corresponding to a current interaction point on the analysis page, the second page being one of the first page or the downstream page;
display a mode switching control;
determine a second view mode in response to an interaction operation for the mode switching control; and
switch the second page to the second view mode for display.

12. The electronic device of claim 11, wherein the second view mode comprises an image view, the second page is displayed in a form of a first image, the page analysis information comprises an interaction analysis result of respective functional areas on the second page, a page image of the second page is displayed on the second page, and the page analysis information about the second page is displayed over the functional area corresponding to the page image.

13. The electronic device of claim 11, wherein the second view mode comprises a trend view, the page analysis information comprises indicator trend information on at least one first analysis indicator, the second page is represented in a form of a second image, and the indicator trend information on the at least one first analysis indicator is displayed on the second page.

14. The electronic device of claim 11, wherein the second view mode comprises a card view, the second page is represented in a form of a card, the page analysis information comprises an analysis result of at least one second analysis indicator, and the analysis result of the at least one second analysis indicator and a page image of the second page are displayed on the second page.

15. The electronic device of claim 11, wherein the second view mode comprises an operation view, the page image of the second page and the interaction object information about the second page are displayed on the second page, the interaction analysis result of the interaction area is displayed over the interaction area of the page image, and the page analysis information comprises the interaction object information and the interaction analysis result of the interaction area.

16. The electronic device of claim 15, wherein the computer instructions, when executed by the processor, further cause the electronic device to:
display the page image of the second page and the interaction object information about a first interaction area in response to a selection operation for the first interaction area.

17. The electronic device of claim 16, wherein the computer instructions, when executed by the processor, further cause the electronic device to:
display an interaction description of a target interaction object corresponding to the second page in response to a selection operation for the target interaction object in the interaction object information about the first interaction area, the interaction description comprising an interaction event and an interaction time corresponding to the interaction event.

18. The electronic device of claim 17, wherein the computer instructions, when executed by the processor, further cause the electronic device to:
display at least one interaction trajectory line in the page image of the second page, a number of the at least one interaction trajectory line being determined based on a time interval between two adjacent interaction events, the interaction event corresponding to an interaction position in the page image of the second page, and the interaction trajectory line being used to represent a connection line between the interaction positions.

19. A non-transitory computer-readable storage medium, wherein the computer-readable storage medium stores computer instructions, and the computer instructions are used to cause a computer to:
determine a target analysis condition and a first page meeting the target analysis condition, in response to an interaction operation for an analysis condition area on an analysis page; and
display the first page, a downstream page of the first page, and a link relationship between the pages in a display area on the analysis page by using a first view mode, the downstream page being determined based on an operation link of the first page, and page analysis information about a corresponding page being displayed on the first page and the downstream page.

20. The non-transitory computer-readable storage medium of claim 19, wherein the computer instructions are further used to cause a computer to:
acquire a second page corresponding to a current interaction point on the analysis page, the second page being one of the first page or the downstream page;
display a mode switching control;
determine a second view mode in response to an interaction operation for the mode switching control; and
switch the second page to the second view mode for display.
